(19) United States
(12) Patent Application Publication
(10) Pub. No.: US 2007/0136404 A1
(43) Pub. Date: Jun. 14, 2007

(54) Display device with electromagnetic interference shield

(75) Inventors: Jing-Lin Zhang, Chu Nan (TW); Man-Vai Lei, Chu Nan (TW)

Correspondence Address: Paul D. Greeley;Ohlandt, Greeley, Ruggiero & Perle, L.L.P., 10th Floor, One Landmark Square, Stamford, CT, 06901-2682, US

(73) Assignee: Coretronic Corporation

(21) Appl. No.: 11/546,825

(22) Filed: Oct. 12, 2006

(30) Foreign Application Priority Data
Nov. 21, 2005 (TW) 094140802

(51) Int. Cl. G06F 15/02

(52) U.S. Cl. 708/130

(57) ABSTRACT

A display device includes a display panel unit, a flexible cable, an electronic module, and a shield. The display panel has a side. The flexible cable is mounted on and extends along the side of the display panel unit, and is coupled electrically to the display panel unit. The electronic module is disposed on the side of the display panel unit, and is coupled electrically to display panel unit. The shield is disposed between the flexible cable and the electronic module. Accordingly, electromagnetic interference between the flexible cable and the electronic module can be prevented.

### CROSS-REFERENCE TO RELATED APPLICATION

This application claims priority of Taiwanese application no. 094140802, filed on Nov. 21, 2005.

### BACKGROUND OF THE INVENTION

1. Field of the Invention

This invention relates to a display device, more particularly to a display device that includes an electromagnetic interference shield.

2. Description of the Related Art

A conventional display device includes a display panel unit, a flexible cable, and an electronic module. The display panel unit is generally rectangular in shape, and has opposite left and right sides, and opposite top and bottom sides. The flexible cable is mounted on and extends along the left side of the display panel unit. The electronic module is disposed at the bottom side of the display panel unit between the left and right sides of the display panel unit, and includes a circuit board that is coupled electrically to the display panel unit, and a plurality of input/output terminals, each of which is mounted on the circuit board and is coupled electrically to the display panel unit via the circuit board.

The aforementioned conventional display device is disadvantageous in that access to the input/output terminals of the electronic module is inconvenient.

It has been proposed heretofore to dispose the electronic module at the left side of the display panel unit to solve the above problem. This, however, results in electromagnetic interference between the electronic module and the flexible cable.

### SUMMARY OF THE INVENTION

Therefore, the object of the present invention is to provide a display device that can overcome the aforesaid drawbacks of the prior art.

According to the present invention, a display device comprises a display panel unit, a flexible cable, an electronic module, and a shield. The display panel unit has a side. The flexible cable is mounted on and extends along the side of the display panel unit, and is coupled electrically to the display panel unit. The electronic module is disposed on the side for mounting the flexible cable, and is coupled electrically to display panel unit. The shield is disposed between the flexible cable and the electronic module for preventing electromagnetic interference therebetween.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a display device according to a preferred embodiment of the present invention;

FIG. 2 is a partly exploded perspective view to illustrate a flexible cable, an electronic module, and a shield according to the preferred embodiment of the present invention; and

FIG. 3 is a perspective view of the display device according to a preferred embodiment of the present invention.

### DETAILED DESCRIPTION OF THE PREFERRED EMBODIMENT

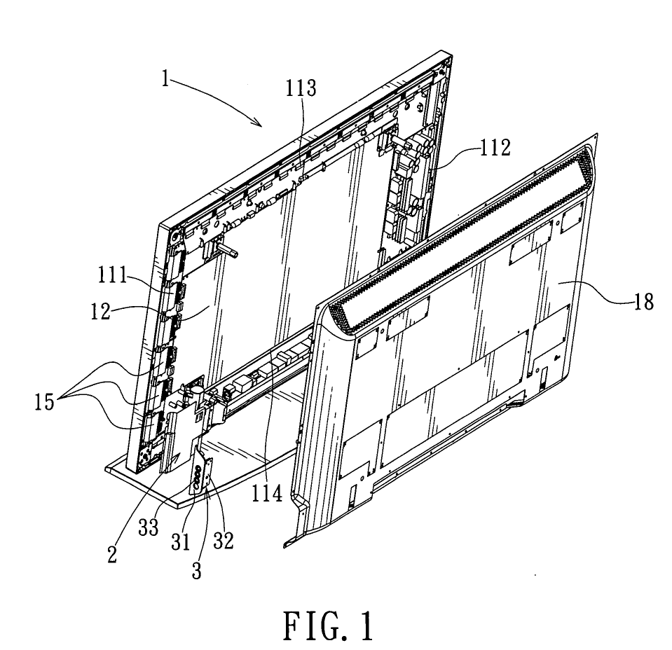

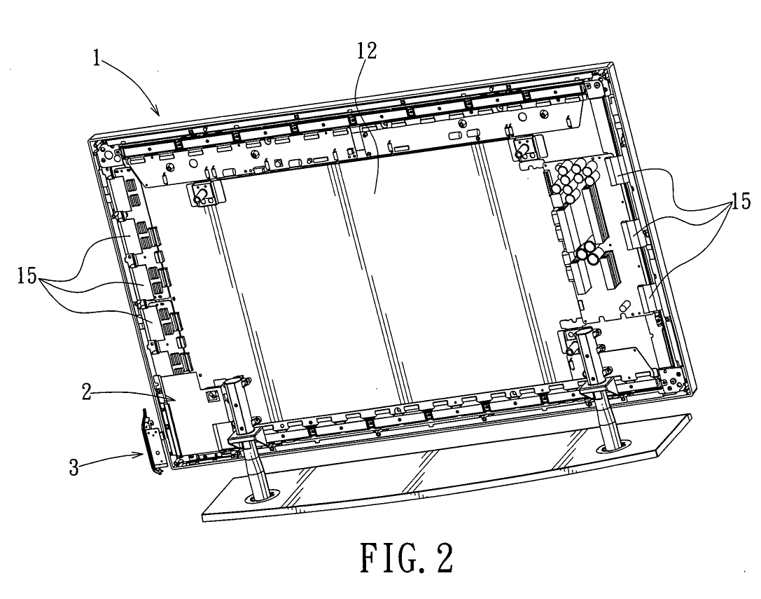

Referring to FIGS. 1 and 2, a display device according to a preferred embodiment of the present invention is shown to include a display panel unit 1, a flexible cable 15, an electronic module 3, and a shield 2.

The display panel unit 1 is generally rectangular in shape, has opposite left and right sides 111, 112, and opposite top and bottom sides 113, 114, and includes a display panel 12 and a mainboard.

In this embodiment, the display panel 12 of the display panel unit 1 is a plasma display panel. In an alternative embodiment, the display panel 12 of the display panel unit 1 is a liquid crystal display panel.

The mainboard of the display panel unit 1 is coupled electrically to and controls the display panel 12 of the display panel unit 1, in a manner well known in the art.

The flexible cable 15 is mounted on and extends along the left side 111 of the display panel unit 1, and is coupled electrically to the display panel 12 of the display panel unit 1.

The electronic module 3 is disposed on the side for mounting the flexible cable 15 and is disposed adjacent to a lower left corner of the display panel unit 1. The electronic module 3 includes a mounting board 31, a circuit board 32, and a plurality of the electric components 33. The mounting board 31 of the electronic module 3 extends transversely of the display panel unit 1, and has opposite first and second ends that are respectively proximate to and distal from the display panel unit 1. The circuit board 32 of the electronic module 3 has an end connected to the second end of the mounting board 31, extends transversely of the mounting board 3 and toward the right side 112 of the display panel unit 1, and is coupled electrically to the mainboard of the display panel unit 1. Each of the electric components 33 is mounted on the mounting board 31 of the electronic module 3 and is coupled electrically to the mainboard of the display panel unit 1 via the circuit board 32 of the electronic module 3. In this embodiment, each of the electric components 33 of the electronic module 3 is an input/output terminal. In an alternative embodiment, each of the electric components 33 of the electronic module 3 is a push button switch.

The shield 2 is mounted on the display panel unit 1. The shield 2 is disposed between the flexible cable 15 and the electronic module 3. Accordingly, electromagnetic interference between the flexible cable 15 and the electronic module 3 can be prevented. In this embodiment, the shield 2 is a metal plate.

It is noted that a gap (not shown) is disposed between the flexible cable 15 and the shield 2. Moreover, the shield 2 has an area that is larger than that of the electronic module 3. Further, in this embodiment, the electronic module 3 is mounted on a surface of the shield 2 away from the flexible cable 15.

The display device further includes a protective covering 18 that is mounted on a periphery of the display panel unit 1, and that is formed with an opening for permitting access to the input/output terminals 33 of the electronic module 3. Since the construction of the protective covering 18 is known to those skilled in the art, a detailed description of the same will be dispensed with herein for the sake of brevity.

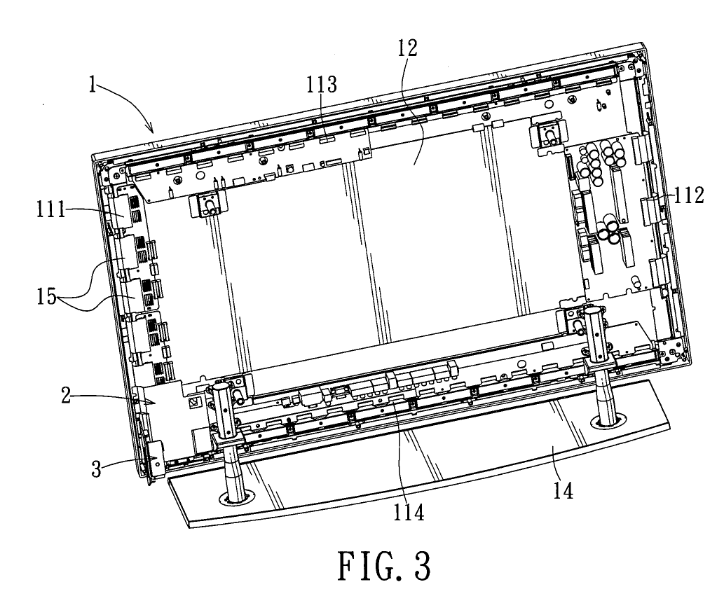

With reference to FIG. 3, the display device further includes a stand 14 that is connected to the display panel unit 1 for supporting the display device on a flat surface (not shown).

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A display device, comprising:
a display panel unit having a side;
a flexible cable mounted on and extending along said side of said display panel unit, and coupled electrically to said display panel unit;
an electronic module disposed on said side for mounting said flexible cable, and coupled electrically to said display panel unit; and
a shield disposed between said flexible cable and said electronic module for preventing electromagnetic interference therebetween.

2. The display device as claimed in claim 1, wherein said shield is a metal plate.

3. The display device as claimed in claim 1, wherein said electronic module includes a mounting board mounted on said side of said display panel unit, a circuit board connected to said mounting board and coupled electrically to said display panel unit, and a plurality of electric components mounted on said circuit board and coupled electrically to said display panel unit via said circuit board.

4. The display device as claimed in claim 1, wherein each of said electric components is an input/output terminal.

5. The display device as claimed in claim 1, wherein said shield is mounted on said display panel unit.

6. The display device as claimed in claim 1, wherein said display panel unit further includes a display panel, said display panel being one of a plasma display panel and a liquid crystal display panel.
